(19) United States
(12) Patent Application Publication
(10) Pub. No.: US 2009/0231759 A1
(43) Pub. Date: Sep. 17, 2009

(54) HEAD SLIDER, HEAD ASSEMBLY AND INFORMATION STORAGE DEVICE

(75) Inventor: Masaki Kameyama, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/331,738

(22) Filed: Dec. 10, 2008

(30) Foreign Application Priority Data
Mar. 17, 2008 (JP) 2008-067438

(51) Int. Cl. G11B 5/60

(52) U.S. Cl. 360/234.3; G9B/5.229

(57) ABSTRACT

A head slider body includes a main body having a protruding air bearing surface, and a wall portion protruding from the air bearing surface near one end in one axial direction of the main body. Extending in the other axial direction in the air bearing surface, a groove portion extends between the wall portion and the air bearing surface in the main body. A read/write head is provided near the other end in the one axial direction of the head slider body.

### BACKGROUND OF THE INVENTION

1. Field of the Invention

The embodiments discussed herein are directed to a head slider, a head assembly, and an information storage device, and more particularly to a head slider including a read/write head, a head assembly including the head slider, and an information storage device including the head assembly.

2. Description of the Related Art

Magnetic storage devices, for example, hard disk drives (hereinafter referred to as “HDDs”) have been used in external magnetic storage devices of computers or consumer video storage devices, or the like. In recent years, users often handle information including large amounts of data (for example, moving images), and HDDs for storing the information require a large capacity, a high speed, low cost, and high reliability.

A magnetic head used in an HDD is held by a head slider, and while the head slider is kept lifted several tens nm above a magnetic disk medium, a read/write operation is performed by the magnetic head. In this case, a bit length of the magnetic disk medium can be shorter for a smaller flying height of the head slider (a narrower space between the head slider and the magnetic disk medium), and thus reducing the flying height is very effective for achieving higher density of the magnetic disk medium.

However, if foreign matter (contamination) in the HDD is caught between the head slider and the magnetic disk medium, a smaller space between the head slider and the magnetic disk medium, that is, a smaller flying height of the head slider may more frequently cause attitude changes of the head slider or damage to the magnetic disk medium or the magnetic head. This may reduce read/write performance of the HDD.

In this respect, recently proposed inventions relate to a shield plate intended for reducing an amount of dust entering a magnetic head (magnetic head core portion) (Japanese Patent Laid-open No. 55-129970) and a contact portion for protecting a magnetic head (magnetic transducer) from damage caused by foreign matter adhering to a disk medium (Japanese Patent Laid-open No. 8-279130).

However, a recent head slider is lifted in an inclined manner with respect to a magnetic disk medium surface, for example, as described in Japanese Patent Laid-open No. 2005-182883. In this case, an end from which air flows in (that is, an air inflow end) is further away from the magnetic disk medium surface than an end from which air flows out. Even if the shield plate (contact portion) described in the above-referenced patent documents is provided at the end from which air flows in, the shield plate (contact portion) has the same height as a surface (air bearing surface) facing a disk medium of the head slider. Thus, foreign matter (dust) entering between the head slider and the magnetic disk medium cannot be reduced.

Also, providing the shield plate (contact portion) on the head slider may affect a lift characteristic of the head slider. For example, when the shield plate (contact portion) is provided on the head slider to reduce a flying height of the head slider, the magnetic head and the magnetic disk medium may come into contact with each other and become damaged, causing read/write errors or the like.

Thus, a head slider, a head assembly, and an information storage device according to an embodiment of the present invention are achieved in view of the above described problems, and have an object to provide a head slider and a head assembly that prevent foreign matter (dust) from entering between the head slider and a disk medium, and obtain an appropriate flying height.

### SUMMARY

In accordance with an aspect of embodiments, a head slider body includes a main body having a protruding air bearing surface, and a wall portion protruding from the air bearing surface near one end in one axial direction of the main body. A groove portion extending in the other axial direction is formed between the wall portion and the air bearing surface in the main body, and a read/write head is provided near the other end in the one axial direction of the head slider body.

Other features and advantages of embodiments of the invention are apparent from the detailed specification and, thus, are intended to fall within the scope of the appended claims. Further, because numerous modifications and changes will be apparent to those skilled in the art based on the description herein, it is not desired to limit the embodiments of the invention to the exact construction and operation illustrated and described, and accordingly all suitable modifications and equivalents are included.

### BRIEF DESCRIPTION OF THE DRAWINGS

FIG. 1 is a perspective view of an internal configuration of an HDD according to an embodiment;

FIGS. 2A and 2B are a perspective view and a vertical sectional view of an HGA in FIG. 1;

FIG. 3 is a perspective view of a head slider;

FIGS. 4A and 4B are a plan view and a side view of the head slider;

FIG. 5 shows a lift state of the head slider;

FIGS. 6A, 6B and 6C illustrate a conventional head slider;

FIGS. 7A and 7B are a table and a graph showing effectiveness of a dustproof rail provided on a head slider of the embodiment as compared with the conventional head slider;

FIGS. 8A, 8B and 8C show a first variant of a dustproof rail;

FIGS. 9A, 9B, 9C and 9D illustrate an operation of the variant in FIG. 8;

FIGS. 10A, 10B and 10C show a second variant of a dustproof rail;

FIGS. 11A and 11B show a third variant of a dustproof rail; and

FIGS. 12A and 12B show a fourth variant of a dustproof rail.

### DETAILED DESCRIPTION OF EXAMPLE EMBODIMENTS

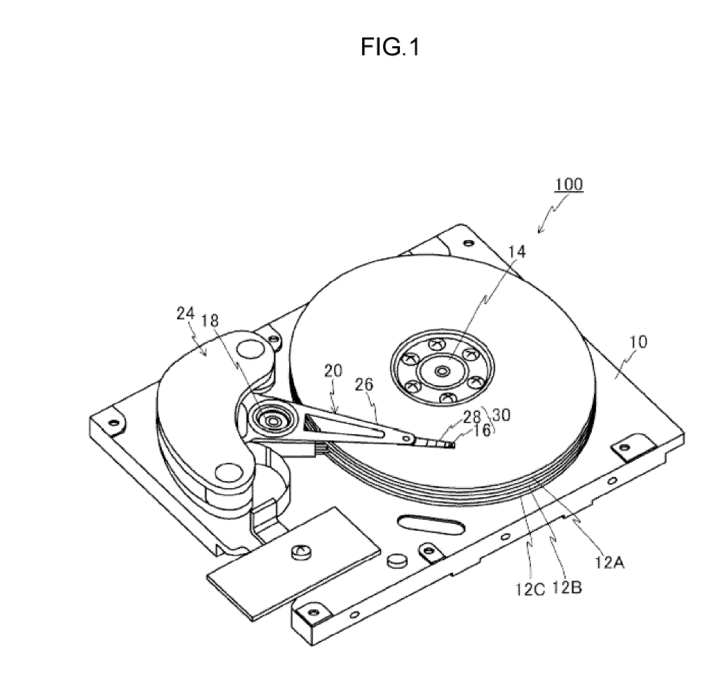

Now, an embodiment of the present invention will be described in detail with reference to FIGS. 1 to 7.

FIG. 1 shows an internal configuration of a hard disk drive (HDD) 100 as an example of an information storage device according to an embodiment. As shown in FIG. 1, the HDD 100 includes a base 10, three magnetic disks 12A, 12B and 12C provided on the base 10, a spindle motor 14, and a head stack assembly (HSA) 20, or the like. The base 10 actually constitutes a box-shaped casing together with an upper lid (top cover) provided to cover an upper surface of the base 10, but in FIG. 1, the top cover is not shown for convenience in drawing.

The magnetic disks 12A to 12C have recording surfaces on front and back surfaces, and each magnetic disk is rotationally driven integrally around a rotating shaft by a spindle motor 14 at a high speed of, for example, 4200 to 15000 rpm.

The HSA 20 is connected rotatably around a support shaft 18, and pivoted around the support shaft 18 by a voice coil motor 24. The HSA 20 includes six head arms 26, and six head gimbal assemblies (HGA) 30 mounted to tips of the head arms 26.

The head arm 26 has a substantially isosceles triangular shape on plan view (viewed from above), and is formed by, for example, stamping a stainless sheet or extruding aluminum material.

The HGA 30 includes an elastic suspension 28, and a head slider 16 provided at one end (an end on the side opposite from the support shaft 18) of the elastic suspension 28.

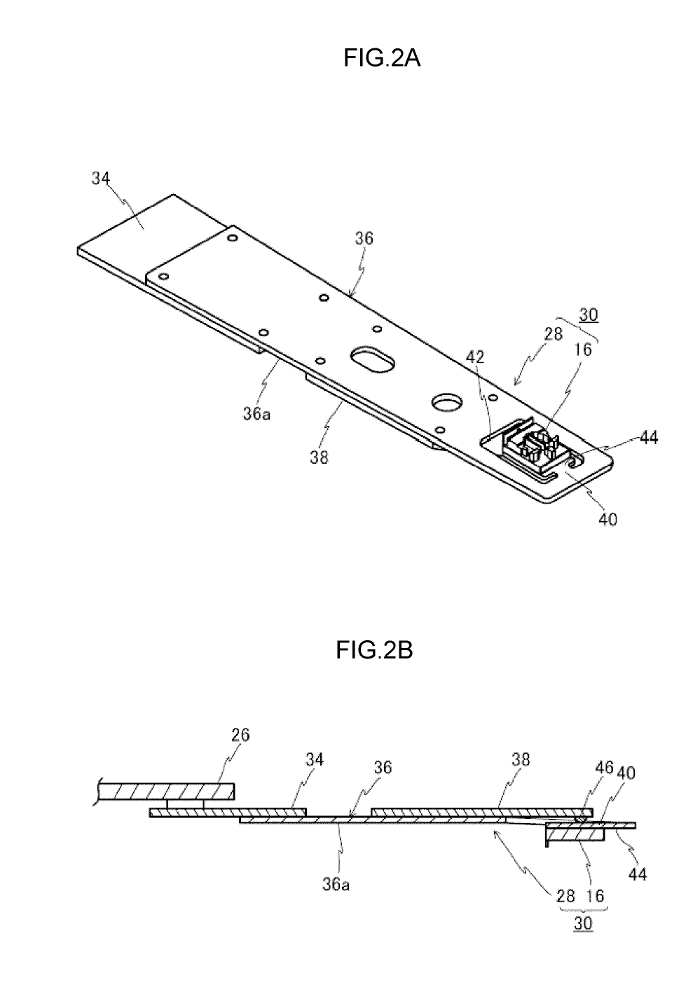

Now, a detailed configuration of the HGA 30 will be described in detail with reference to FIGS. 2A and 2B. FIG. 2A is a perspective view of an HGA 30 in an uppermost position among the six HGAs 30 in FIG. 1 viewed from the side of the head slider 16 (back side), and FIG. 2B is a vertical sectional view of the HGA 30.

As shown in the drawings, the elastic suspension 28 that constitutes the HGA 30 includes a spacer 34 secured to one end (an end on the side opposite from the support shaft 18) of the head arm 26, a load beam 36 partly secured to the spacer 34, and a reinforcing plate 38 secured to the load beam 36.

The load beam 36 is made of, for example, stainless steel, and as shown in FIG. 2A, a substantially U-shaped slit 42 is formed near one end thereof (an end on the side opposite from the end to which the spacer 34 is secured). Thus, the slit 42 is formed in the load beam 36 and thus a gimbal 40 is integrally formed in the load beam 36. The gimbal 40 has a head slider holding surface 44 for holding the head slider 16 on one surface (an upper surface in FIG. 2A and a lower surface in FIG. 2B). In the load beam 36, a portion between a portion to which the reinforcing plate 38 is secured and a portion to which the spacer 34 is secured is an elastically deformable spring portion 36a.

The reinforcing plate 38 is made of, for example, stainless steel, and as shown in FIG. 2B, a semispherical pivot 46 is provided in part on a surface (lower surface in FIG. 2B) facing the gimbal 40. The pivot 46 abuts the gimbal 40 from above, and thus the gimbal 40 can be deformed around the pivot 46 in a vertical direction, a pitch direction, and a roll direction. Thus, the head slider 16 held by the gimbal 40 can be changed in attitude in the same direction.

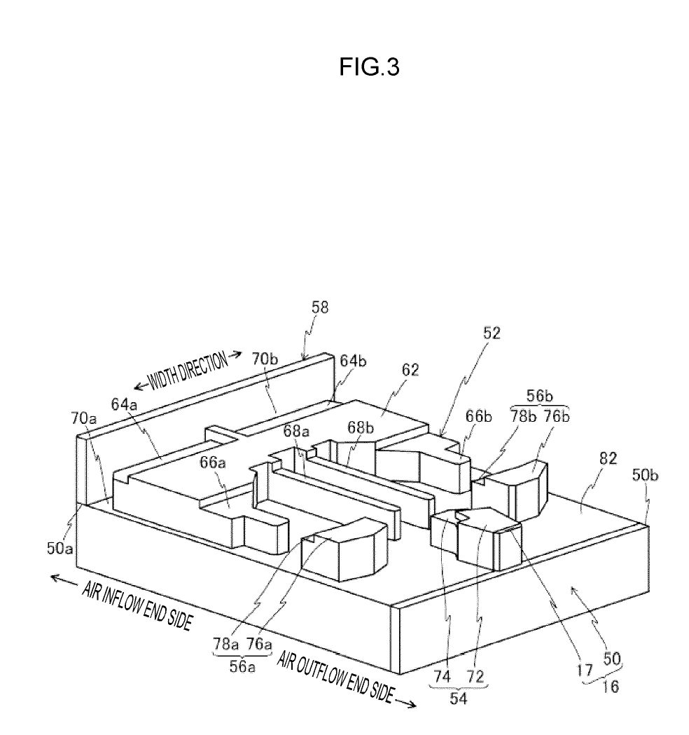

Next, a configuration of the head slider 16 or the like will be described in detail with reference to FIGS. 3 to 7.

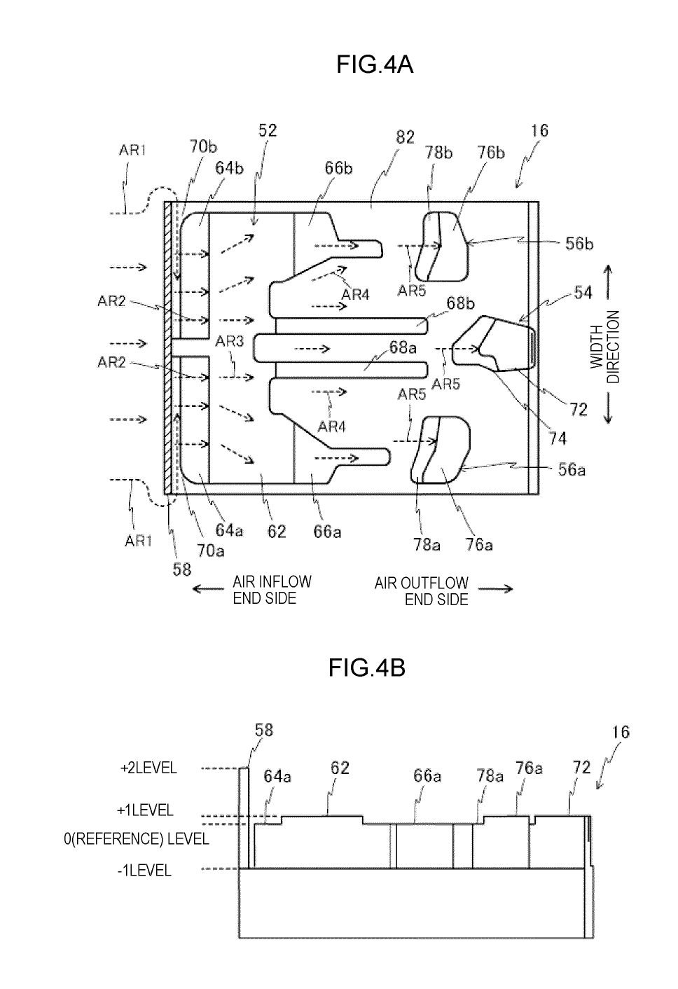

FIG. 3 is a perspective view of the head slider 16, FIG. 4A is a plan view of the head slider 16, and FIG. 4B is a side view of the head slider 16. As shown in the drawings, the head slider 16 includes a head slider body 50, and a read/write head element 17 provided on the side of an air outflow end 50b of the head slider body 50. The head slider body 50 may be made of, for example, Al₂O₃—TiC (AlTiC).

The read/write head element 17 includes, for example, a recording element that writes data in the magnetic disk 12A using a magnetic field produced by a thin film coil pattern, and a reading element such as a giant magnetoresistance effect element (GMR) or a tunnel junction magnetoresistance effect element (TuMR) that reads data from the magnetic disk 12A using resistance changes of a spin-valve film or a tunnel junction film. At the air outflow end 50b on which the read/write head element 17 is provided, an alumina film of several tens μm is formed so as to cover the read/write head element 17.

The head slider body 50 has a complicated shape with a plurality of irregularities on an upper surface portion in FIG. 3. Surfaces having different heights that constitute the upper surface portion are positioned, as shown in FIG. 4B, at “+2 level”, “+1 level”, “0 (reference) level”, and “−1 level” in order from higher to lower. In the embodiment, for example, a dimension between the +2 level and the +1 level is 50 nm, a dimension between the +1 level and the 0 level is 0.2 μm, and a dimension between the +1 level and the −1 level is 2 μm. In FIGS. 3 and 4B, or the like, the dimensions are not necessarily as mentioned above for convenience in drawing and description.

More specifically, as shown in FIG. 3, the head slider body 50 includes a front rail 52 placed on the side of an air inflow end 50a, a rear center rail 54 and rear side rails 56a and 56b placed on the side closer to the air outflow end 50b than the front rail 52, and a dustproof rail 58 placed on the side closer to the air inflow end 50a than the front rail 52. The rails are formed by milling a rectangular parallelepiped member (a member finally forming the head slider body 50) originally having a height of the +2 level or higher by an exposure technique using a photo mask or a resist. On a surface of each rail, a protective film of, for example, DLC (diamond like carbon) is formed.

The front rail 52 has an air bearing surface 62 as a air bearing surface extending in a width direction of the head slider body 50 at the +1 level, and step surfaces (64a, 64b, 66a, 66b, 68a and 68b) at the 0 (reference) level. More specifically, the step surfaces include a pair of front step surfaces 64a and 64b on the side of the air inflow end 50a of the air bearing surface 62, and a pair of side step surfaces 66a and 66b and a pair of center step surfaces 68a and 68b on the side of the air outflow end 50b of the air bearing surface 62.

The rear center rail 54 is provided substantially at the center in the width direction of the head slider body 50 on the side closer to the air outflow end 50b than the front rail 52, and includes an air bearing surface 72 as an air bearing surface at the +1 level, and a step surface 74 at the 0 (reference) level.

The rear side rails 56a and 56b are provided near opposite ends in the width direction of the head slider body 50 on the side closer to the air outflow end 50b than the front rail 52. One rear side rail 56a has an air bearing surface 76a as a air bearing surface at the +1 level, and a step surface 78a at the 0 level. The other rear side rail 56b has an air bearing surface 76b as a air bearing surface at the +1 level and a step surface 78b at the 0 level.

The dustproof rail 58 has a substantially rectangular shape, and is provided over the entire width of the head slider body 50 at the air inflow end 50a of the head slider body 50 so as to have the height of the +2 level.

Portions other than the front rail 52, the rear center rail 54, the rear side rails 56a and 56b, and the dustproof rail 58 all have the height of the −1 level. More specifically, on the side closer to the air outflow end 50b than the front rail 52, a portion other than the rear center rail 54 and the rear side rails 56a and 56b is a recess 82 having a relatively large area. Also, a pair of groove portions 70a and 70b extend in the width direction of the head slider body 50 between the dustproof rail 58 and the front rail 52.

The head slider body 50 thus configured has, in other words, a structure including a main body (a portion other than the dustproof rail 58) having protruding air bearing surfaces (air bearing surfaces (62, 72, 76a and 76b)), and the dustproof rail 58 protruding from the air bearing surfaces (air bearing surfaces (62, 72, 76a and 76b)) near the air inflow end 50a and extending in the width direction, and the groove portions 70a and 70b extending in the width direction are formed between the dustproof rail 58 and the air bearing surfaces (air bearing surfaces (62, 72, 76a, 76b)).

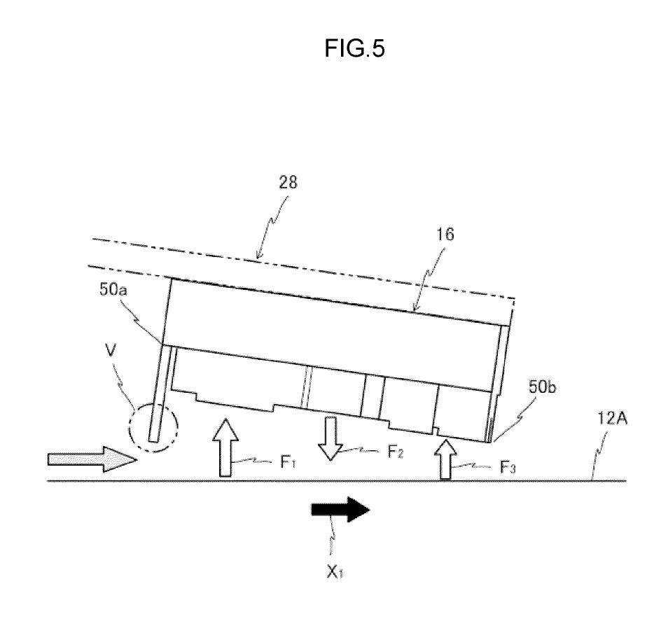

Next, the principle of lifting of the head slider 16 above the magnetic disk 12A will be described with reference to FIGS. 4 and 5.

While the magnetic disk 12A is rotationally driven by the spindle motor 14 in a predetermined rotational direction (the direction of black arrow X1 in FIG. 5), the head slider 16 is positioned above the magnetic disk 12A by the voice coil motor 24. Then, an air flow generated on a surface of the magnetic disk 12A by rotation of the magnetic disk 12A enters between the dustproof rail 58 and the magnetic disk 12A, and part of an air flow colliding with the dustproof rail 58 flows around the dustproof rail 58 and enters the groove portions 70a and 70b as shown by dotted arrow AR1 in FIG. 4A. The air entering the groove portions 70a and 70b and the air entering between the dustproof rail 58 and the magnetic disk 12A collides with steps between the front step surfaces 64a and 64b and the air bearing surface 62 of the front rail 52 as shown by dotted arrow AR2 in FIG. 4A, and the air is compressed by the collision (pressure is increased).

Then, when the compressed air moves to between the air bearing surface 62 and the magnetic disk 12A as shown by dotted arrow AR3 in FIG. 4A, the compressed air applies pressure between the air bearing surface 62 and the magnetic disk 12A to produce buoyancy as shown by open arrow F1 in FIG. 5.

Then, the compressed air that has applied pressure between the air bearing surface 62 and the magnetic disk 12A moves from the front rail 52 toward the recess 82 as shown by dotted arrow AR4 in FIG. 4A. The air having flown into the recess 82 expands in the recess 82 to generate negative pressure. The negative pressure generates a force directed from the head slider 16 to the magnetic disk 12A as shown by open allow F2 in FIG. 5.

Further, also in the rear center rail 54 and the rear side rails 56a and 56b, as shown by dotted arrow AR5 in FIG. 4A, when air collides with steps between the step surfaces 74, 78a and 78b and the air bearing surfaces 72, 76a and 76b, the air is compressed, and the compressed air applies pressure between the air bearing surfaces 72, 76a and 76b and the magnetic disk 12A to produce buoyancy as shown by open arrow F3 in FIG. 5.

A pressing force from the elastic suspension 28 toward the surface of the magnetic disk 12A is applied to the head slider 16, and thus a balance between the pressing force and the buoyancy (F1 and F3) and the force by the negative pressure (F2) applied to the head slider 16 causes the head slider 16 to be kept lifted above the magnetic disk 12A with relatively high rigidity during rotation of the magnetic disk 12A.

In this case, the air bearing surface 62 that constitutes the front rail 52 has a larger area than the total area of the air bearing surfaces 72, 76a and 76b of the rear center rail 54 and the rear side rails 56a and 56b, and thus the buoyancy (F1 in FIG. 5) generated on the front rail 52 is higher than the buoyancy (F3 in FIG. 5) generated on the rear center rail 54 and the rear side rails 56a and 56b. Thus, the head slider 16 of the embodiment is lifted so that the air inflow end 50a is higher than the air outflow end 50b with respect to the magnetic disk 12A as shown in FIG. 5. An inclination angle (pitch angle) of the head slider 16 in this case is, for example, 200 μrad.

In the embodiment, as described above, the head slider 16 is lifted in an inclined manner (so that the air inflow end 50a is higher than the air outflow end 50b), and dust easily enters between the head slider 16 and the magnetic disk 12A. Thus, in the embodiment, to minimize entering of dust, the dustproof rail 58 provided at the air inflow end 50a of the head slider body 50 protrudes from the air bearing surfaces (62, 76a, 76b and 72). Now, an experiment for checking the effect of the dustproof rail 58 will be briefly described.

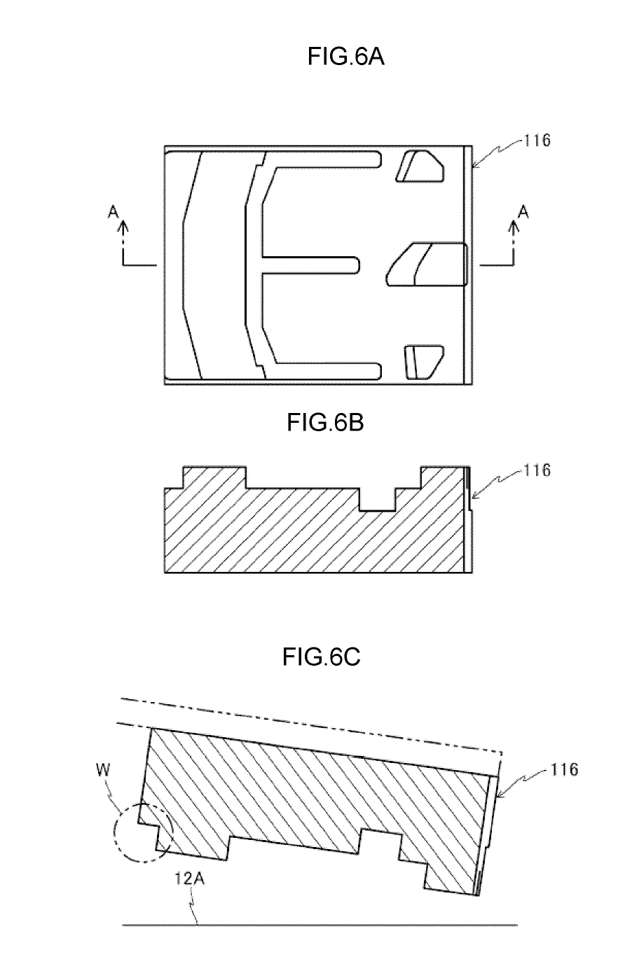

FIG. 6A is a plan view of a conventional head slider 116 (a head slider without a dustproof rail), and FIG. 6B is a sectional view taken along the line A-A in FIG. 6A. As shown in FIG. 6C, the conventional head slider is also lifted above a magnetic disk 12A so that an air inflow end 50a is higher than an air outflow end 50b like the head slider 16 of the embodiment.

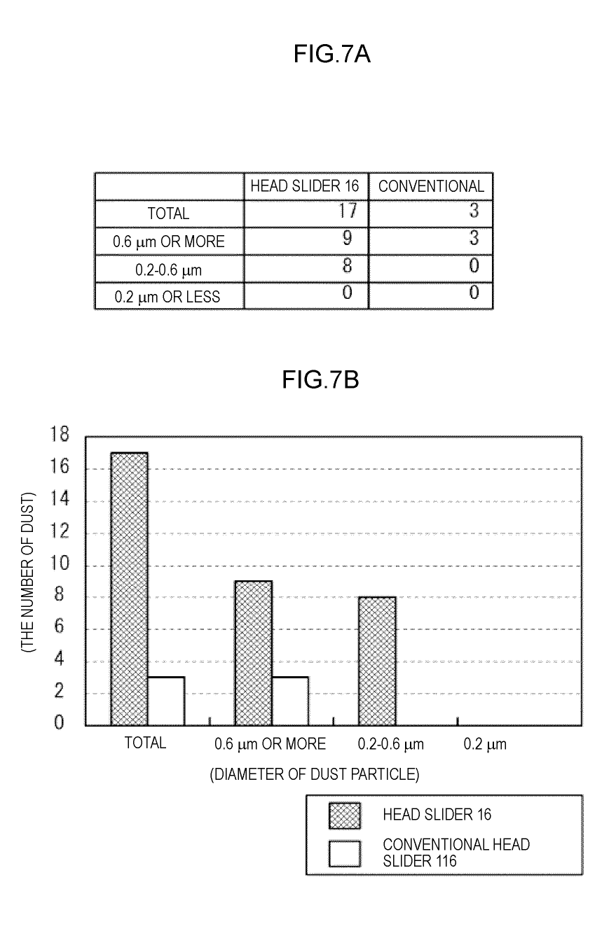

The inventor lifted the conventional head slider 116 and the head slider 16 of the embodiment above a magnetic disk 12A intentionally contaminated (a magnetic disk 12A to which large amounts of dust adhere), and analyzed how much dust adheres to a particular portion on each of the head sliders 116 and 16 while the magnetic disk 12A rotates for a predetermined time (or for a predetermined number of turns). The particular portion is a portion near the air inflow end (reference character W in FIG. 6C) for the conventional head slider 116, and a portion near a lower end (reference character V in FIG. 5) of the dustproof rail 58 for the head slider 16 of the embodiment. In this case, the inventor performed the analysis by observing a predetermined range such as one shot (for example, a width of 70 μm) with an SEM (Scanning Electron Microscope), and counting the number of dust particles adhering to the range for each size (diameter) of the dust particles. FIGS. 7A and 7B are a table and a graph showing the analysis result.

The analysis result (FIGS. 7A and 7B) reveals that the amount of dust captured at the dustproof rail 58 in the embodiment is much larger than the amount of dust captured at the air inflow end of the conventional head slider 116 (about six times in total). Specifically, from this result, it can be supposed that the dustproof rail 58 newly provided in the embodiment can effectively capture dust that cannot be captured by the conventional head slider 116, and thus the amount of dust entering between the head slider 16 and the magnetic disk 12A can be reduced as compared with the conventional head slider.

The counting method of the number of dust particles is not limited to the above, but the number of dust particles may be counted over the entire particular portion on each head slider, or a plurality of shots may be observed with the SEM to calculate a statistical calculation result such as an average value of the results. Also, the number of dust particles (the amount of dust) may be counted (calculated) by weighting calculation in view of the size of the dust particle.

In the embodiment, as described above, the dustproof rail 58 can be provided to reduce the amount of dust entering between the head slider 16 and the magnetic disk 12A as compared with the conventional example. Also, the groove portions 70a and 70b are provided, and thus even if a flow of air to be supplied from the air inflow end to the air bearing surface 62 or the like is blocked by the dustproof rail 58, air flowing around the dustproof rail 58 is efficiently supplied to the air bearing surface 62 or the like through the groove portions 70a and 70b formed near the dustproof rail 58 (see dotted arrows AR1, AR2 and AR3 in FIG. 4A), and the dustproof rail 58 can be provided without any trouble, allowing the flying height of the head slider 16 to be appropriately maintained.

Returning to FIG. 1, other HGAs 30 (HGAs in second to sixth positions from the top) that constitute the HSA 20 have the same configuration as described above. Thus, the descriptions of the other HGAs will be omitted.

As described above in detail, according to the embodiment, the head slider 16 includes the dustproof rail 58, and the dustproof rail 58 prevents dust from entering between the head slider 16 and the magnetic disk 12A. This can prevent damage to the magnetic disk 12A or the read/write head element 17 and read/write errors due to dust being caught between the head slider 16 and the magnetic disk 12A. In the embodiment, the dustproof rail 58 is provided, and thus even if the flow of air to be supplied to the air bearing surface 62 or the like is blocked, air flowing around the dustproof rail 58 is efficiently supplied to the air bearing surface 62 and the like through the groove portions 70a and 70b formed near the dustproof rail 58, allowing the flying height of the head slider 16 to be appropriately maintained. The HDD 100 of the embodiment includes the head slider 16 (or the HGA 30) that can maintain the appropriate flying height, and thus can achieve read/write with high accuracy and high recording density.

In the embodiment, the portion of the head slider 16 facing the magnetic disk is constituted by a combination of four types of surfaces having different heights, and thus the head slider 16 can be formed only by milling a wafer or the like (without polishing or the like).

In the embodiment, the case of adopting the dustproof rail 58 having a substantially rectangular shape has been described, but is not limited to this as a dustproof rail having a different shape may be adopted.

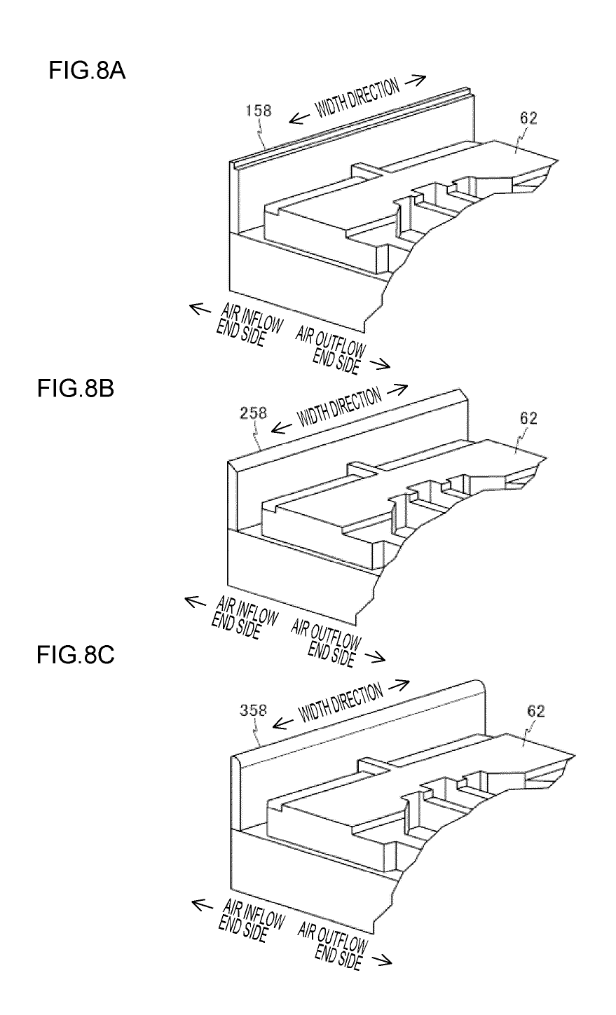

Specifically, for example, as shown in FIGS. 8A to 8C, dustproof rails (158, 258 and 358) having different heights at an end on the side of the air inflow end and at an end on the side of the air outflow end (the latter is lower) may be adopted. In this case, for example, as the dustproof rail 158 in FIG. 8A, the height may be changed stepwise from the end on the side of the air inflow end toward the end on the side of the air outflow end. Specifically, an end surface (an upper surface in FIG. 8A) on a protruding side of the dustproof rail 158 may be formed closer to the air bearing surface 62 or the like stepwise from the end on the side of the air inflow end toward the end on the side of the air outflow end. The embodiment is not limited to the case where the height is changed in only one step as shown in FIG. 8A, but the height may be changed in two or more steps.

As the dustproof rail 258 in FIG. 8B, the height may be changed linearly (continuously) from the end on the side of the air inflow end toward the end on the side of the air outflow end, or as the dustproof rail 358 in FIG. 8C, the height may be changed roundedly (continuously) from the end on the side of the air inflow end toward the end on the side of the air outflow end. Specifically, as the dustproof rails (258 and 358), end surfaces (upper surfaces in FIGS. 8B and 8C) on a protruding side may be formed closer to the air bearing surface 62 or the like linearly or roundedly from the end on the side of the air inflow end toward the end on the side of the air outflow end. The dustproof rails 258 and 358 can be produced (formed), for example, by forming a dustproof rail having a flat plate shape (rectangular shape) as the dustproof rail 58 in the embodiment on the head slider, then lifting the head slider above a polishing medium rotating at a predetermined rotation speed, and bringing the dustproof rail into contact with the polishing medium at an appropriate angle (pitch angle) with an appropriate pressing force.

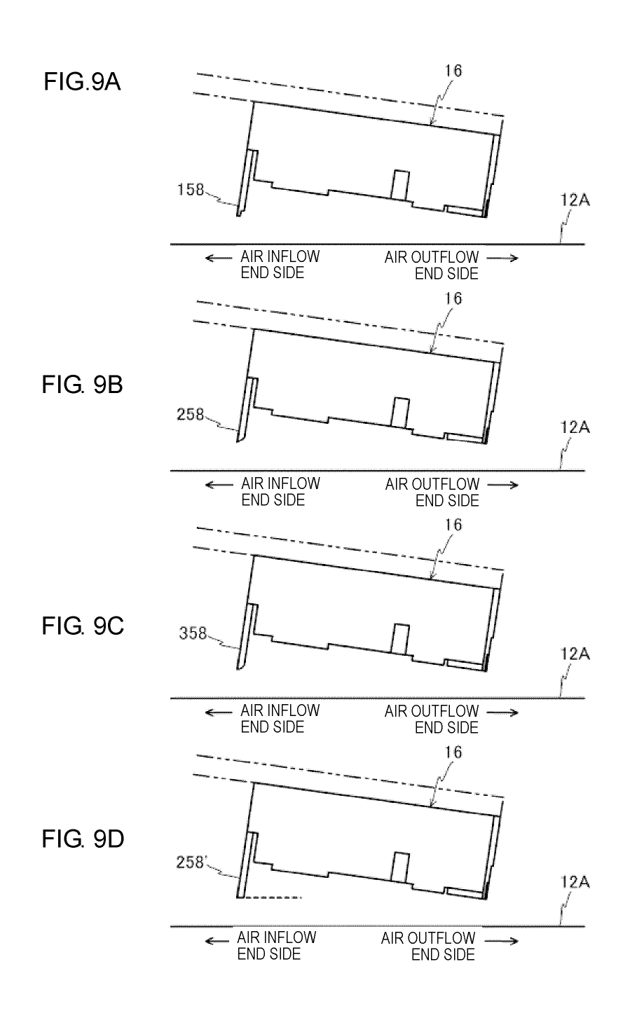

In any of FIGS. 8A to 8C, as shown in FIGS. 9A to 9C, when the head slider 16 is lifted above the magnetic disk 12A, the end on the side of the air outflow end cannot be lower than the end on the side of the air inflow end (in FIG. 9A, near the end). This can maintain the dustproof effect by the dustproof rail, and ensure an adequate flying height between the head slider and the magnetic disk.

In place of FIG. 9B, as shown in FIG. 9D, a dustproof rail 258′ may be adopted having a lower end that becomes parallel to the magnetic disk surface when the head slider 16 is lifted above the magnetic disk. In this case, an angle at the lower end of the dustproof rail 258′ may be the same as the inclination angle (for example, 200 μrad) of the head slider 16. Thus, even if the rotation of the magnetic disk 12A suddenly stops to bring the surface of the magnetic disk 12A into contact with the dustproof rail 258, a contact area between the dustproof rail 258 and the magnetic disk 12A can be larger than in FIG. 9B or the like. This can prevent damage to the surface of the magnetic disk 12A.

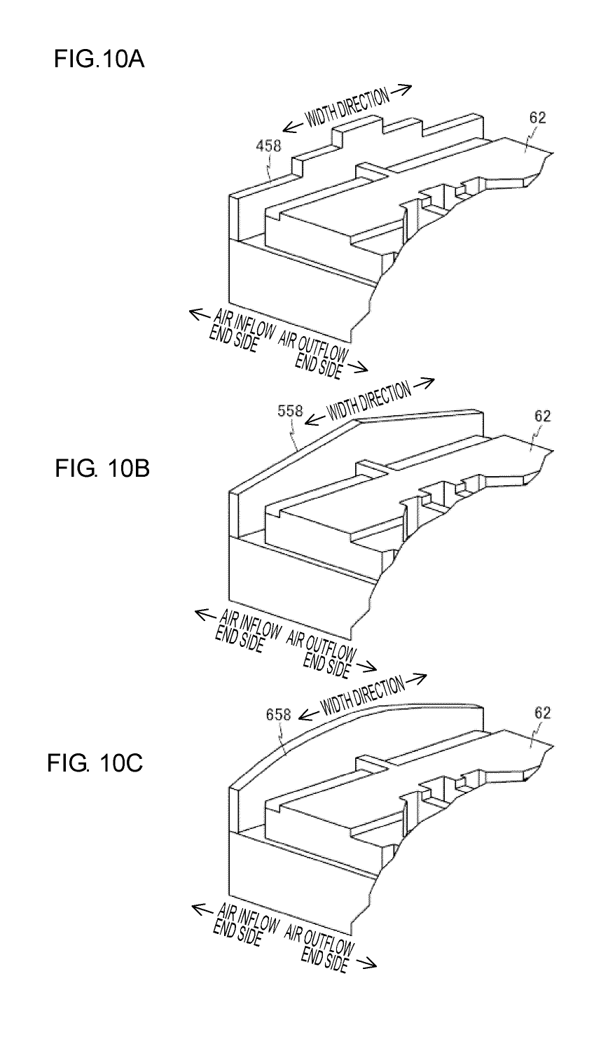

In the embodiment, the dustproof rail 58 having a uniform height in the width direction of the head slider 16 is adopted, but is not limited to this, for example, as shown in FIGS. 10A to 10C, dustproof rails (458, 558 and 658) may be adopted having different heights at a central position in the width direction and at opposite ends in the width direction (the opposite ends are lower). For example, as the dustproof rail 458 in FIG. 10A, the height may be reduced stepwise from the central portion in the width direction toward the opposite ends in the width direction of the head slider 16. Specifically, an end surface (upper surface in FIG. 9A) on a protruding side of the dustproof rail 458 may be formed closer to the air bearing surface 62 or the like stepwise from the central portion in the width direction toward the opposite ends in the width direction. In FIG. 10A, the height is reduced in two steps, but is not limited to this. The height may be reduced in one step or multiple steps. Also, as the dustproof rail 558 in FIG. 10B, the height may be reduced linearly (continuously) from the central portion in the width direction toward the opposite ends in the width direction of the head slider 16, or as the dustproof rail 658 in FIG. 10C, the height may be reduced roundedly (continuously) from the central portion in the width direction toward the opposite ends in the width direction of the head slider 16. Specifically, as the dustproof rails (558 and 658), end surfaces (upper surfaces in FIGS. 9B and 9C) on a protruding side may be formed closer to the air bearing surface 62 or the like continuously (linearly or roundedly) from the central portion in the width direction toward the opposite ends in the width direction. In any case, even if the head slider 16 rolls to some extent (performs a rotation operation in an air inflow direction), contact between each of the dustproof rails 458, 558 and 658 and the surface of the magnetic disk 12A can be prevented. In view of capturing efficiency of dust, the height of the opposite ends in the width direction of each of the dustproof rails 458, 558 and 658 is desirably the +1 level or higher in FIG. 4B.

The dustproof rail 558 can be produced (formed), for example, by forming a dustproof rail having a flat plate shape (rectangular shape) as the dustproof rail 58 in the embodiment on the head slider, then lifting the head slider above a polishing medium rotating at a predetermined rotation speed, and bringing corners of the dustproof rail into contact with the polishing medium at an appropriate angle (a rolling angle) with an appropriate pressing force. The dustproof rail 658 can be produced (formed), for example, by forming a dustproof rail having a flat plate shape (rectangular shape) on the head slider, then lifting the head slider above a polishing medium rotating at a predetermined rotation speed, and bringing the dustproof rail into contact with the polishing medium and causing the dustproof rail to reciprocate a predetermined number of times within a predetermined angle (the rolling angle).

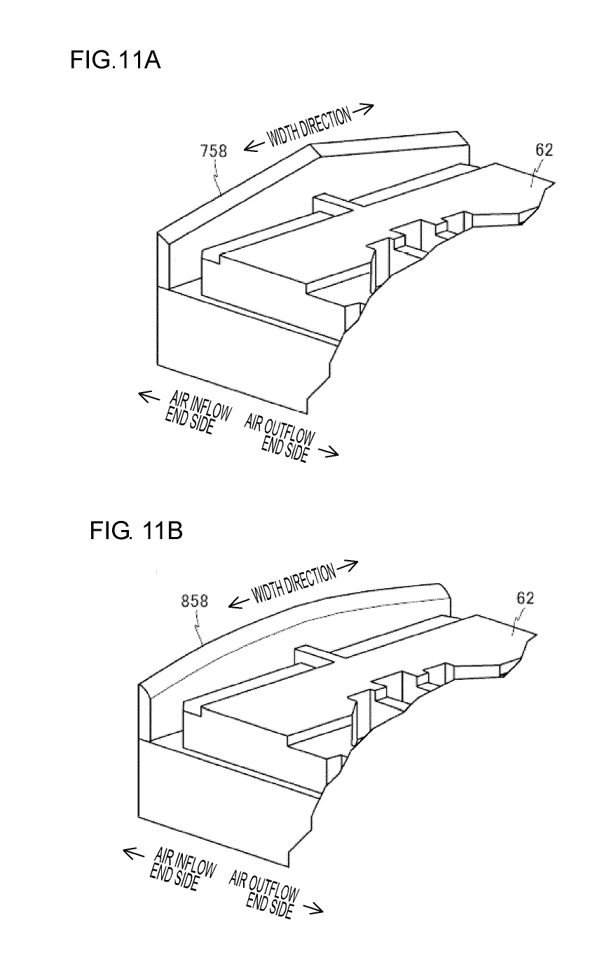

The concept of the variant in FIGS. 8A to 8C (or FIGS. 9A to 9D) and the concept of the variant in FIGS. 10A to 10C may be combined. For example, as a dustproof rail 758 in FIG. 11A, the height may be changed linearly (continuously) from the end on the side of the air inflow end toward the end on the side of the air outflow end, and the height may be changed linearly (continuously) from the central portion toward the opposite ends in the width direction, or for example, as a dustproof rail 858 in FIG. 11B, the height may be changed roundedly (continuously) from the end on the side of the air inflow end toward the end on the side of the air outflow end, and the height may be changed roundedly (continuously) from the central portion toward the opposite ends in the width direction. Thus, the advantages of both the variants can be simultaneously achieved. The embodiments are not limited to the combinations in FIGS. 11A and 11B, as a dustproof rail with a combination of any of FIGS. 8A to 8C and any of FIGS. 10A to 10C may be adopted. In any case, the same advantage as the combinations in FIGS. 11A and 11B can be achieved.

In the embodiment, as shown in FIG. 3, the case where the dustproof rail 58 is provided (formed) over the entire width of the head slider 16 has been described, but is not limited to this. For example, when a method of collectively forming a plurality of head sliders in one member (one wafer) and finally cutting the member into a plurality of thin head sliders is adopted in production of a head slider (head slider body), the opposite ends in the width direction of the dustproof rail 58 may be positioned slightly inwardly of the opposite ends in the width direction of the head slider body 50 for ensuring cutting margins (for preventing deformation of or damage to the dustproof rail caused by the cutting).

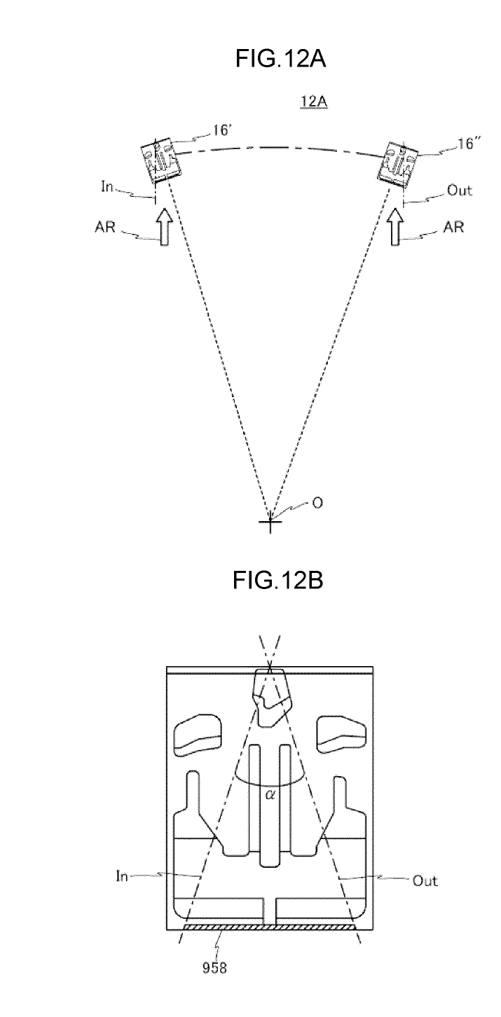

In the embodiment, the HSA 20 pivots around the rotating shaft of the support shaft 18, and thus as shown in FIG. 12A, the head slider 16 arcuately moves (seeks) around a rotation shaft 0 above the magnetic disk 12A. Thus, the dustproof rail may be provided in a range where the air flow AR (that is, dust flowing with the air flow AR) can be prevented from coming into contact with the read/write head element 17 when the head slider 16 is positioned on the innermost side of the magnetic disk 12A (denoted by reference character 16′ in FIG. 12A), and the air flow (dust) can be prevented from coming into contact with the read/write head element 17 when the head slider 16 is positioned on the outermost side of the magnetic disk 12A (denoted by reference character 16″ in FIG. 12A). Specifically, as a dustproof rail 958 in FIG. 12B, the dustproof rail may have a width including a maximum yaw angle α (an angle between a line In and a line Out) in a seek. Thus, the advantage as in the above described embodiment can be achieved, and the width of the dustproof rail can be minimized, thereby reducing the weight of the head slider.

The above described embodiment is a preferred embodiment of the present invention. But not limited to this, various modifications may be made without departing from the gist of the present invention.

What is claimed is:

1. A head slider comprising:
a head slider body including a main body having a protruding air bearing surface, and a wall portion protruding from the air bearing surface near one end in one axial direction of the main body, and
extending in the other axial direction in the air bearing surface, a groove portion extending in the other axial direction is formed between the wall portion and the air bearing surface in the main body; and
a read/write head provided near the other end of the head slider body.

2. The head slider according to claim 1, wherein the wall portion protrudes so that a central portion of the head slider body is higher than portions near the other end.

3. The head slider according to claim 2, wherein an end surface on a protruding side of the wall portion is formed closer to a height of the air bearing surface stepwise from the central portion toward the opposite ends.

4. The head slider according to claim 2, wherein an end surface on a protruding side of the wall portion is formed closer to a height of the air bearing surface continuously from the central portion toward the opposite ends.

5. The head slider according to claim 4, wherein the end surface on the protruding side of the wall portion is formed closer to the height of the air bearing surface roundedly from the central portion toward the opposite ends.

6. The head slider according to claim 1, wherein the wall portion protrudes so that one end in the one axial direction is higher than the other end.

7. The head slider according to claim 6, wherein an end surface on a protruding side of the wall portion is formed closer to a height of the air bearing surface stepwise from one end toward the other end in the one axial direction.

8. The head slider according to claim 6, wherein an end surface on a protruding side of the wall portion is formed closer to a height of the air bearing surface continuously from one end toward the other end in the one axial direction.

9. The head slider according to claim 8, wherein the end surface on the protruding side of the wall portion is formed closer to the height of the air bearing surface roundedly from one end toward the other end in the one axial direction.

10. The head slider according to claim 1, wherein the wall portion is provided over the entire width in the other axial direction of the slider body.

11. A head assembly comprising:
a suspension;
a head slider mounted near a tip of the suspension; and
wherein the head slider comprising:
a head slider body including a main body having a protruding air bearing surface, and a wall portion protruding from the air bearing surface near one end in one axial direction of the main body, and
extending in the other axial direction in the air bearing surface, a groove portion extending in the other axial direction is formed between the wall portion and the air bearing surface in the main body; and
a read/write head provided near the other end of the head slider body.

12. An information storage device comprising:
a disk medium;
an arm driven in writing information in the disk medium or reading the information; and
a suspension connected to the arm;
a head slider mounted at a tip of the suspension; and
wherein the head slider comprising:
a head slider body including a main body having a protruding air bearing surface, and a wall portion protruding from the air bearing surface near one end in one axial direction of the main body, and
extending in the other axial direction in the air bearing surface, a groove portion extending in the other axial direction is formed between the wall portion and the air bearing surface in the main body; and
a read/write head provided near the other end of the head slider body.

13. The information storage device according to claim 12, wherein the head slider is lifted above the disk medium and arcuately seeks, and a width the wall portion in the other axial direction set within maximum yaw angle in the seek.

14. The information storage device according to claim 12, wherein the wall portion has a portion facing the disk medium that becomes parallel to the disk medium surface when the head slider is lifted above the disk medium.
